(19) United States
(12) Patent Application Publication
(10) Pub. No.: US 2021/0013541 A1
(43) Pub. Date: Jan. 14, 2021

(54) COMPOSITE ELECTRODE CONTAINING SULFIDE-BASED SOLID ELECTROLYTE AND ALL-SOLID-STATE BATTERY USING SAME

(71) Applicant: INDUSTRY-UNIVERSITY COOPERATION FOUNDATION HANYANG UNIVERSITY, Seoul (KR)

(72) Inventors: Dong Wook SHIN, Gyeonggi-do (KR); Sun Ho Choi, Incheon (KR); Ji Yae Do, Seoul (KR); Seungwoo Lim, Seoul (KR); Ji U An, Gyeonggi-do (KR)

(73) Assignee: INDUSTRY-UNIVERSITY COOPERATION FOUNDATION HANYANG UNIVERSITY, Seoul (KR)

(21) Appl. No.: 16/924,949

(22) Filed: Jul. 9, 2020

(30) Foreign Application Priority Data
Jul. 10, 2019 (KR) 10-2019-0083470

(51) Int. Cl. H01M 10/0562; H01M 4/36; H01M 4/136; H01M 4/58; H01M 4/134; H01M 10/0525

(52) U.S. Cl. CPC H01M 10/0562; H01M 4/364; H01M 4/136; H01M 2004/028; H01M 4/134; H01M 4/366; H01M 10/0525; H01M 4/58

(57) ABSTRACT

Example embodiments of the present invention provide an all-solid-state battery. The all-solid-state battery comprises a solid electrolyte layer, a positive electrode layer disposed on one side of the solid electrolyte layer, and a negative electrode layer disposed on the other side of the solid electrolyte layer. At least one of the positive electrode layer and the negative electrode layer is provided with a composite electrode layer comprising an electrode active material and a solid electrolyte. The solid electrolyte comprises a mixture of a sulfide-based glass ceramic and a sulfide-based crystalline. The all-solid-state battery according to the embodiment of the present invention has an excellent contact area between particles in the composite electrode included in the all-solid-state battery, so that the electrochemical characteristics of the all-solid-state battery including the same can be improved.

### CLAIM FOR PRIORITY

This application claims priority to Korean Patent Application No. 10-2019-0083470 filed on Jul. 10, 2019 in the Korean Intellectual Property Office (KIPO), the entire contents of which are hereby incorporated by reference.

### BACKGROUND

### 1. Technical Field

Example embodiments of the present invention relate to an all-solid-state battery, and more particularly to an all-solid-state battery comprising a sulfide-based solid electrolyte.

### 2. Related Art

With the widespread use of small electronic devices and electric vehicles, demand for secondary batteries having high energy density is increasing. Recently, a lithium secondary battery using lithium ions as a secondary battery has been researched and used a lot.

Since the conventional lithium secondary battery uses a flammable liquid electrolyte, the risk of ignition and explosion is very high, strict packaging is required, and accordingly, there is a problem that it is difficult to increase energy density above a certain level. In addition, the lithium secondary battery using a liquid electrolyte has a very high risk of ignition and explosion due to flammable materials.

To overcome this, research into an all-solid-state secondary battery in which a flammable liquid electrolyte is replaced with a safer inorganic ceramic material has been attempted. All-solid-state secondary batteries have high energy density and safety, and are attracting attention as next-generation secondary batteries.

In particular, the solid electrolyte used in the lithium secondary battery may be classified into an oxide-based solid electrolyte and a sulfide-based solid electrolyte, and among them, the sulfide-based solid electrolyte shows a higher ion conductivity than the oxide-based solid electrolyte. It has little deterioration in properties even in extreme environments and has a great advantage in designing a secondary battery with high energy density.

However, the all-solid-state battery containing a solid electrolyte has a low electrochemical performance and a high processing cost, so it has not yet reached the commercialization stage. The insufficient electrochemical performance has various problems, but the most prominent problem is that as the solid electrolyte is used, there are voids at the interface between the electrode active material particles and the electrolyte particles inside the electrode, so the contact of the interface is lowered due to the voids.

Therefore, in order to exhibit excellent performance of the all-solid-state battery, it is required to improve the contact characteristics between particles in the all-solid-state battery.

### SUMMARY

Accordingly, example embodiments of the present invention are provided to substantially obviate one or more problems due to limitations and disadvantages of the related art.

Example embodiments of the present invention provide an all-solid-state battery. The all-solid-state battery comprises a solid electrolyte layer, a positive electrode layer disposed on one side of the solid electrolyte layer, and a negative electrode layer disposed on the other side of the solid electrolyte layer. At least one of the positive electrode layer and the negative electrode layer is provided with a composite electrode layer comprising an electrode active material and a solid electrolyte. The solid electrolyte comprises a mixture of a sulfide-based glass ceramic and a sulfide-based crystalline.

The sulfide-based glass ceramic may have a Young's modulus of 14 to 20 E/GPa, and the sulfide-based crystalline may have a Young's modulus of 22 to 30 E/GPa.

The solid electrolyte contained in the composite electrode layer may include the sulfide-based crystalline of 10 to 90 weight ratio based on the weight of the mixture of the sulfide-based glass ceramic and the sulfide-based crystalline. Specifically, the solid electrolyte contained in the composite electrode layer may include the sulfide-based crystalline of 70 to 80 weight ratio.

The sulfide-based crystalline may have an argyrodite-type crystal structure. The sulfide-based crystalline may be Li₆PS₅X, and X is Cl, Br, or I. The sulfide-based glass ceramic may include lithium sulfide and phosphorus sulphide. The sulfide-based glass ceramic may further include a lithium salt. For example, the sulfide-based glass ceramic may include 70 to 80 mol % of the lithium sulfide, 20 to 25 mol % of the phosphorus sulphide, and 0 to 5 mol % of a lithium salt. The lithium salt may be lithium sulfate.

The positive electrode layer may be the composite electrode layer, and the electrode active material may contain lithium-transition metal oxide or lithium-transition metal phosphate. The solid electrolyte layer contains a solid electrolyte, and the solid electrolyte contained in the solid electrolyte layer may have a different composition from the solid electrolyte contained in the composite electrode layer. The negative electrode layer may include Li, In, Al, Si, Sn, Ti, or any one of these alloys.

In other example embodiments, a composite electrode is provided. The composite electrode comprises an electrode active material and a solid electrolyte. The solid electrolyte comprises a mixture of a glass ceramic solid electrode and a crystalline solid electrode.

The crystalline solid electrolyte is a sulfide-based crystalline having an argyrodite-type crystal structure. Specifically, the sulfide-based crystalline is Li₆PS₅X, and X is Cl, Br, or I. The glass ceramic solid electrolyte may be a sulfide-based glass ceramic represented by the following Chemical Formula 1 or Chemical Formula 2:

(100-y)(xLi₂S-(1-x)P₂S₅)-y(salt) [Chemical Formula 1]

In the Chemical Formula 1, x may be 0.5 to 0.8, and y may be 0 to 5.

yLi₂S-(100-y-x)P₂S₅-x(salt) [Chemical Formula 2]

In the Chemical Formula 2, y may be 50 to 80, and x may be 0 to 5.

The salt may be lithium salt.

The solid electrolyte may contain 70 to 80 parts by weight of the crystalline solid electrolyte and 20 to 30 parts by weight of the glass ceramic solid electrolyte.

The electrode active material may contain lithium-transition metal oxide or lithium-transition metal phosphate.

### BRIEF DESCRIPTION OF DRAWINGS

Example embodiments of the present invention will become more apparent by describing in detail example embodiments of the present invention with reference to the accompanying drawings, in which:

FIG. 1 is a cross-sectional view schematically showing a cross-section of an all-solid-state battery according to an embodiment of the present invention;

FIGS. 2A, 2B, 2C, 2D, and 2E are SEM (Scanning Electron Microscope) images showing the microstructures of the composite electrodes in all-solid-state batteries according to All-solid-state battery Comparative Examples 1, 2, and All-solid-state battery Preparation Examples 1 to 3, respectively;

FIG. 3 is a graph showing porosity of the solid electrolyte layers according to Solid electrolyte layer Preparation Examples and Solid electrolyte layer Comparative Examples and porosity of the composite electrodes of all-solid-state batteries according to All-solid-state battery Preparation Examples and All-solid-state battery Comparative Examples;

FIGS. 4A, 4B, and 4C are SEM images showing microstructures when molding pressure for the solid electrolyte layer according to Solid electrolyte layer Comparative Example 1 is 100 MPa, 300 MPa, and 500 MPa, respectively, and FIGS. 4D, 4E, and 4F are SEM images showing microstructures when molding pressure for the solid electrolyte layer according to Solid electrolyte layer Comparative Example 2 is 100 MPa, 300 MPa, and 500 MPa, respectively;

FIG. 5 is a graph showing the relative density according to the molding pressure for the solid electrolyte layers according to Solid electrolyte layer Comparative Examples 1 and 2;

FIG. 6 is a graph showing discharge characteristics of all-solid-state batteries according to All-solid-state battery Examples;

FIG. 7 is a graph showing resistance characteristics of solid electrode layers according to Solid electrode layer Preparation Examples and Comparative Examples; and

FIG. 8 is a graph showing rate performance of all-solid-state batteries according to All-solid-state battery Preparation Examples and Comparative Examples.

### DESCRIPTION OF EXAMPLE EMBODIMENTS

The present invention can be applied to various changes and can have various embodiments, and specific embodiments will be illustrated in the drawings and described in detail. However, this is not intended to limit the present invention to specific embodiments, and should be understood to include all modifications, equivalents, and substitutes included in the spirit and scope of the present invention.

When an element, such as a layer, region, or substrate, is referred to as being “on” another component, it will be understood that it may be present directly on the other element or intermediate elements may be present therebetween.

The terms used in this application are only used to describe specific embodiments, and are not intended to limit the present invention. Singular expressions include plural expressions unless the context clearly indicates otherwise. In this application, the terms “include” or “have” are intended to indicate that a feature, number, step, action, component, part, or combination thereof described on the specification exists, and that one or more other features are present. It should be understood that the existence or addition possibilities of fields or numbers, steps, operations, components, parts or combinations thereof are not excluded in advance.

Unless defined otherwise, all terms used herein, including technical or scientific terms, have the same meaning as commonly understood by a person skilled in the art to which the present invention pertains. Terms such as those defined in a commonly used dictionary should be interpreted as having meanings consistent with meanings in the context of related technologies, and should not be interpreted as ideal or excessively formal meanings unless explicitly defined in the present application.

As used herein, “glass ceramic” may be a material having an amorphous phase and one or more crystalline phases, and is used in the same concept as crystallized glass.

All-Solid-State Battery

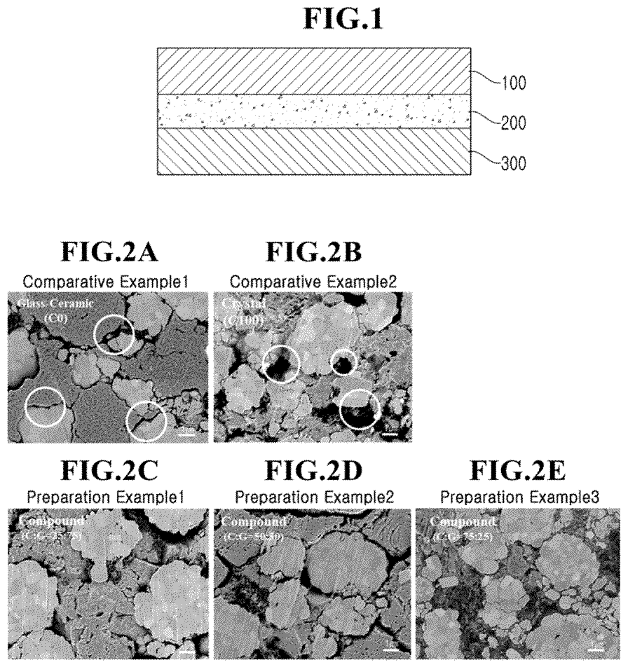

FIG. 1 is a cross-sectional view schematically showing a cross-section of an all-solid-state battery according to an embodiment of the present invention.

Referring to FIG. 1, the all-solid-state battery according to the present invention may include a solid electrolyte layer 200, a positive electrode layer 100, and a negative electrode layer 300. The positive electrode layer 100 may be disposed on one side of the solid electrolyte layer 200, the negative electrode layer 300 may be disposed on another side of the solid electrolyte layer 200, the positive electrode layer 100 and the negative electrode layer 300 may be disposed on side surfaces of the solid electrolyte layer 200 that face each other.

The solid electrolyte layer 200 may include a sulfide-based compound, specifically, a sulfide-based solid electrolyte. The sulfide-based solid electrolyte may include sulfide-based glass ceramic, sulfide-based crystalline or a mixture thereof. For description of the sulfide-based glass ceramic and the sulfide-based crystalline, reference will be made to the description of the composite electrode described later. However, the present invention is not limited thereto, and the solid electrolyte layer 200 may include other known solid electrolytes.

At least one of the positive electrode layer 100 and the negative electrode layer 300 may include a composite electrode layer, as described in detail below. The composite electrode layer may include a solid electrolyte and an electrode active material, and the electrode active material may be a positive electrode active material or a negative electrode active material. That is, the positive electrode layer 100 may include the positive electrode active material, and the negative electrode layer 300 may include the negative electrode active material.

In this case, the composition of the solid electrolyte contained in the solid electrolyte layer 200 and the composition of the solid electrolyte contained in the positive electrode layer 100 or the negative electrode layer 300, that is, the composition of the solid electrolyte contained in the composite electrode are the same or can be different.

The positive electrode layer 100, the solid electrolyte layer 200, or the negative electrode layer 300 may be formed by preparing a slurry containing the corresponding materials, and then depositing the slurry by tape casting, screen printing, or electrostatic spraying, or may be formed by pressing powder containing the corresponding particles. Next, after laminating each layer, it may be pressed by one or more methods selected from the group consisting of a hot press, a roll press, and a warm hydrostatic press (WIP).

Composite Electrode

A composite electrode according to an embodiment of the present invention includes a current collector and a composite electrode layer formed thereon, and the composite electrode layer may include a solid electrolyte and an electrode active material. The solid electrolyte may have a particle shape and the electrode active material may also have a particle shape.

The solid electrolyte may include a mixture of glass-ceramic solid electrolyte and crystalline solid electrolyte. The glass ceramic solid electrolyte may be particles having a diameter (D50) of several to several tens of micrometers (μm), specifically several micrometers (μm). The crystalline solid electrolyte may be particles having a diameter (D50) of several to several tens of micrometers (μm), specifically several micrometers (μm).

The Young's modulus of the glass ceramic solid electrolyte may be smaller than the Young's modulus of the crystalline solid electrolyte. Specifically, the glass-ceramic solid electrolyte may be sulfide-based glass ceramic, and the crystalline solid electrolyte may be sulfide-based crystalline. The sulfide-based glass ceramic may exhibit a Young's modulus of 14 to 20 E/GPa, and the sulfide-based crystalline may exhibit a Young's modulus of 22 to 30 E/GPa. Since the sulfide-based glass ceramic has a relatively small Young's modulus, the resistance to deformation is relatively small and may have a somewhat soft property. On the other hand, the sulfide-based crystalline has a relatively large Young's modulus, so the resistance to deformation is relatively large, and thus may have a somewhat rigid or hard property. The sulfide-based glass ceramic, which has a relatively small resistance to deformation, may be easily deformed in shape by pressure applied during the formation of an all-solid-state battery and can easily fill voids between particles in the composite electrode.

The sulfide-based glass ceramics have a property of somewhat high cohesiveness, but by mixing with the sulfide-based crystalline, the cohesiveness can be relaxed, thereby improving the contact area within the composite electrode to improve mechanical properties. In addition, the sulfide-based crystalline has a higher electrical conductivity than the sulfide-based glass ceramic, and the mixture of the sulfide-based crystalline and the sulfide-based glass ceramic may have improved electrical properties including ion conductivity compared to the sulfide-based glass ceramic.

The sulfide-based glass ceramic and the sulfide-based crystalline may be mixed in a specific weight ratio, for example, when the mixture of the sulfide-based glass ceramic and the sulfide-based crystalline is 100 parts by weight, the sulfide-based crystalline may be contained in a weight ratio of 10 to 90, a weight ratio of 20 to 80, a weight ratio of 25 to 75, or a weight ratio of 60 to 90, for example, a weight ratio of 70 to 80. When the above weight ratio is satisfied, the somewhat larger cohesiveness of the sulfide-based glass ceramic can be supplemented through mixing with the sulfide-based crystalline, and also due to the rather soft properties of the sulfide-based glass ceramic, porosity between particles in the composite electrode can be significantly reduced. Accordingly, the contact area between the electrode active material and the solid electrolyte in the composite electrode may be improved. Such an improvement in the contact area may result in an improvement in the lithium ion diffusion coefficient since more lithium ion paths are generated. Accordingly, the all-solid-state battery including the composite electrode has improved electrochemical properties, for example, improved lifespan characteristics and rate performance.

The sulfide-based crystalline material may have, for example, a cubic argyrodite-type crystal structure. The sulfide-based crystalline may be, for example, Li₆PS₅X, and X may be Cl, Br, or I.

As an example, the sulfide-based glass ceramic may contain lithium sulfide and phosphorus sulfide. Lithium sulfide may be Li₂S, and phosphorus sulfide may be P₂S₅. In addition, the sulfide-based glass ceramic may further include a salt in addition to lithium sulfide and phosphorus sulfide. The sulfide-based glass ceramic may be represented by the following Chemical Formula 1 or Chemical Formula 2.

(100-y)(xLi₂S-(1-x)P₂S₅)-y(salt) [Chemical Formula 1]

In this case, x may be 0.5 to 0.8, 0.65 to 0.78, 0.7 as an example, and y may be 0 to 10, 1 to 5, 3 as an example.

yLi₂S-(100-y-x)P₂S₅-x(salt) [Chemical Formula 2]

In this case, y may be 50 to 80, 65 to 78, 70 to 77, 75 as an example, and x may be 0 to 10, 1 to 5, 3 as an example.

The salt may be a lithium salt. The lithium salt may be, for example, lithium sulfate (Li₂SO₄), lithium chloride (LiCl), lithium iodide (LiI), trilithium borate (Li₃BO₃) or lithium phosphate (Li₃PO₄). When the sulfide-based glass ceramic contains a salt in addition to sulfide (Li₂S—P₂S₅), ion conductivity may be improved.

Furthermore, the sulfide-based glass ceramic may include 70 to 80 mol % of lithium sulfide, 20 to 25 mol % of phosphorus sulfide, and 0 to 5 mol % of the lithium salt. As an example, the sulfide-based glass ceramic may include 73 to 77 mol % of lithium sulfide, 21 to 23 mol % of phosphorus sulfide, and 2 to 4 mol % of the lithium salt, specifically 74 to 76 mol % of lithium sulfide, 21.5 to 22.5 mol % of phosphorus sulfide, and 2.5 to 3.5 mol % of the lithium salt. The lithium salt may be lithium sulfate. More specifically, the sulfide-based glass ceramic may be 75Li₂S-22P₂S₅₋₃Li₂SO₄.

In terms of ionic conductivity of the solid electrolyte, lithium sulfide may be included at least about 70 mol %. However, when the content of lithium sulfide is excessive, as the amount of lithium sulfide remaining in the finally formed glass ceramic increases, water reactivity and reactivity with the electrode active material interface may increase and electrochemical stability may decrease. Accordingly, the composition of the solid electrolyte may have a content ratio for improving ion conductivity and electrochemical stability while reducing the content of lithium sulfide remaining in the finally formed sulfide-based glass ceramic.

The composite electrode layer may be the positive electrode layer (100 in FIG. 1) or the negative electrode layer (300 in FIG. 1). When the composite electrode layer is the positive electrode layer, the electrode active material may be a positive electrode active material, and when the composite electrode layer is the negative electrode layer, the electrode active material may be a negative electrode active material.

The positive electrode active material may contain lithium-transition metal oxide or lithium-transition metal phosphate. The lithium-transition metal oxide may be a composite oxide of lithium and at least one transition metal selected from the group consisting of cobalt, manganese, nickel, and aluminum. The lithium-transition metal oxide may be, for example, Li_{1±a}(Ni_{1-x-y}CoₓMn_{y})O₂ (0≤a≤0.2, 0≤x≤1, 0≤y≤1, 0≤x+y≤1), Li_{1±a}(Ni_{1-x-y}CoₓAl_{y})O₂ (0≤a≤0.2, 0≤x<1, 0<y<1, 0<x+y≤1), or Li_{1±a}(Ni_{1-x-y}CoₓMn_{y})₂O₄ (0≤a≤0.2, 0≤x≤1, 0≤y≤1, 0≤x+y≤1). The lithium-transition metal phosphate may be a composite phosphate of lithium and at least one transition metal selected from the group consisting of iron, manganese, and nickel. Lithium-transition metal phosphate may be, for example, L_{1±a}(Ni_{1-x-y}MnₓFe_{y})PO₄ (0≤a≤0.2, 0≤x≤1, 0≤y≤1, 0≤x+y≤1). As an example, the positive electrode active material may contain NCM622 (LiNi_{0.6}Co_{0.2}Mn_{0.2}O₂).

The negative electrode active material may include, for example, carbon materials such as graphite, carbon fiber, polyacene, vapor-grown carbon fiber, coke, meso carbon or microbeads, or metals such as Li, In, Al, Si, Sn, Ti, or alloys thereof, but is not limited thereto. As an example, the negative electrode active material may contain lithiated indium, for example Li_{0.5}In.

When the all-solid-state battery is operated, as the electrochemical reaction of the electrode active material is actively performed by the insertion and desertion of lithium, the electrode active material may be expanded in volume by the electrochemical reaction. Due to this volume expansion, as the number of charge/discharge cycles of the all-solid-state battery increases, cracks between the particles and loss of contact area in the composite electrode layer may increase.

However, according to an embodiment of the present invention, when the composite electrode layer contains a mixture of a sulfide-based glass ceramic and a sulfide-based crystalline as a solid electrolyte, the number of charge/discharge cycles of the all-solid-state battery is increased, so that even if the volume expansion of the electrode active material occurs, it is possible to greatly alleviate cracks between particles and loss of contact area.

The composite electrode layer may further include a conductive material. The conductive material serves to improve electron conductivity in the composite electrode layer, and may include carbon, Ni, and the like, but is not limited thereto. For example, when the conductive material contains carbon, carbon black such as super-P, acetylene black, thermal black, channel black, graphite, carbon fiber, and the like may be included.

The composite electrode layer may further include a binder. The binder may serve to increase the binding force between particles in the composite electrode layer and/or the binding force of the composite electrode layer to the current collector. For example, the binder may be selected from the group consisting of nitrile butadiene rubber (NBR), polyvinylpyrrolidone (PVP), polyvinylidene fluoride (PVDF), and mixtures thereof, but is not limited thereto, and may be particularly suitable if the material is not reactive with other materials in the composite electrode layer.

The current collector is made of a conductive material, and may be any material that does not react with the electrode active material. As an example, the metal may be Al, Ti, Cu, Au, Pt, Ni, and the like, but is not limited thereto.

A method of manufacturing a composite electrode according to another embodiment of the present invention may include preparing a slurry for a composite electrode obtained by mixing the solid electrolyte and the electrode active material in a solvent.

The composite electrode slurry may contain 60 to 76 parts by weight of the electrode active material, 20 to 40 parts by weight of the solid electrolyte, and 70 to 130 parts by weight of the solvent. The slurry for the composite electrode may further include 1 to 3 parts by weight of the conductive material and/or 1 to 3 parts by weight of the binder. The solid electrolyte may be a mixture of the sulfide-based glass ceramic and the sulfide-based crystalline in a specific weight ratio. When the mixture of the sulfide-based glass ceramic and sulfide-based crystalline is 100 parts by weight, the sulfide-based crystalline may be contained in 10 to 90 parts by weight, 20 to 80 parts by weight, 25 to 75 parts by weight, or 60 to 90 parts by weight, for example 70 to 80 parts by weight.

The solvent may be an organic solvent, specifically, a non-polar organic solvent or an aprotic organic solvent. As an example, the organic solvent may include aromatic hydrocarbons such as xylene and toluene, cyclic aliphatic hydrocarbons such as cyclopentane, cyclohexane, or chain aliphatic hydrocarbons such as dodecane, heptane, and mixtures thereof.

The composite electrode slurry may be cast on a current collector to form a composite electrode layer. In detail, the slurry for the composite electrode can be applied on the current collector at a speed of 5 to 20 mm/s and a thickness of 200 to 320 μm. Next, the slurry applied on the current collector is dried at 100 to 150° C. for 1 hour to 2 hours to evaporate the remaining organic solvent to form a thick film composite electrode layer. The obtained composite electrode layer may be in the form of a sheet.

The composite electrode layer obtained according to the manufacturing method of the present invention may have little or no porosity. Porosity may be due to poor contact between particles in the composite electrode. Since the composite electrode layer exhibits excellent contact area between particles, it can exhibit excellent ion conductivity. Therefore, in order to improve the ionic conductivity, an additional step such as impregnating the composite electrode layer with a separate liquid or gel or separately coating may not be performed.

Hereinafter, preferred examples are provided to aid the understanding of the present invention. However, the following experimental example is only for helping understanding of the present invention, and the present invention is not limited by the following experimental example.

### EXAMPLES

### All-Solid-State Battery Preparation Example 1

68.1 parts by weight of electrode active material NCM622 (LiNi_{0.6}Co₂Mn_{0.2}O₂), 29.2 parts by weight of solid electrolyte, 1.3 parts by weight of Super-P, and 1.4 parts by weight of nitrile butadiene rubber (NBR) were mixed with xylene in 101.8 parts by weight. The solid electrolyte contained 21.9 parts by weight of 75Li₂S-22P₂S₅-3Li₂SO₄ powder (D50 is 5.92 μm) and 7.3 parts by weight of Li6PS5Cl powder (D50 is 5.88 μm). Here 75Li₂S-22P₂S₅-3Li₂SO₄:Li₆PS₅Cl has a weight ratio of 75:25. The mixing was carried out with a blender at a speed of 2000 to 2500 rpm for 20 to 40 minutes and a slurry was obtained by the mixing. The obtained slurry was cast on aluminum foil at a rate of 10 mm/s and a thickness of 260 μm, and then dried at 100 to 150° C. for 1 to 2 hours to obtain a composite electrode.

The composite electrode was punched to a size of 13 Φ. The composite electrode as a positive electrode layer, Li₆PS₅Cl powder having an argyrodite crystal structure of 0.15 to 2 g as a solid electrolyte layer, and lithiated indium (Li_{0.5}In) as a negative electrode layer were introduced into a mold of 13 D, and a pressure of 300 to 500 MPa was applied for 5 minutes.

An all-solid-state battery was produced by the pressure molding.

### All-Solid-State Battery Preparation Example 2

An all-solid-state battery was prepared in the same manner as in all-solid-state battery Preparation Example 1, except that 14.6 parts by weight of 75Li₂S-22P₂₅-3Li₂SO₄ and 14.6 parts by weight of Li₆PS₅Cl were used as the solid electrolyte in the composite electrode. Here, 75Li₂S-22P₂S₅-3Li₂SO₄:Li₆P₅Cl has a weight ratio of 50:50.

### All-Solid-State Battery Preparation Example 3

An all-solid-state battery was prepared in the same manner as in all-solid-state battery Preparation Example 1, except that 7.3 parts by weight of 75Li₂S-22P₂₅-3Li₂SO₄ and 21.9 parts by weight of Li₆PS₅Cl were used as the solid electrolyte in the composite electrode. Here, 75Li₂S-22P₂S₅-3Li₂SO₄:Li₆P₅Cl has a weight ratio of 25:75.

### All-Solid-State Battery Comparative Example 1

An all-solid-state battery was prepared in the same manner as in all-solid-state battery Preparation example 1, except that 29.2 parts by weight of 75Li₂S-22P₂₅-3Li₂SO₄ was used as the solid electrolyte in the composite electrode. Here, Li₆PS₅Cl was not used, and the solid electrolyte contained 100 wt % of 75Li₂S-22P₂₅-3Li₂SO₄.

### All-Solid-State Battery Comparative Example 2

An all-solid-state battery was prepared in the same manner as in all-solid-state battery Preparation example 1, except that 29.2 parts by weight of Li₆PS₅Cl was used as the solid electrolyte in the composite electrode. Here, 75Li₂S-22P₂S₅-3Li₂SO₄ was not used, and the solid electrolyte contained 100 wt % of Li₆PS₅Cl.

### All-Solid-State Battery Comparative Example 3

An all-solid-state battery was prepared in the same manner as in all-solid-state battery Preparation example 1, except that 29.2 parts by weight of Li₆P₅Cl containing Li₆P₅Cl coarse powder and Li₆PS₅Cl fine powder was used as the solid electrolyte in the composite electrode. Here, 75Li₂S-22P₂S₅-3Li₂SO₄ was not used, and the solid electrolyte contained 100 wt % of Li₆PS₅Cl including 50 wt % of Li₆PS₅Cl coarse powder having 10 to 15 μm particle diameter (D50) and 50 wt % of Li₆PS₅Cl fine powder having 1 to 5 μm particle diameter (D50).

### Solid Electrolyte Layer Preparation Example 1

21.9 parts by weight of 75Li₂S-22P₂S₅-3Li₂SO₄ powder (D50 is 5.92 μm) and 7.3 parts by weight of Li₆PS₅Cl powder (D50 is 5.88 μm) were mixed, put into a mold, and press-molded at a pressure of 300 to 500 MPa for 5 minutes to prepare solid electrolyte layer. Here, 75Li₂S-22P₂S₅-3Li₂SO₄:Li₆PS₅Cl has a weight ratio of 75:25.

### Solid Electrolyte Layer Preparation Example 2

A solid electrolyte layer was prepared in the same manner as in Solid electrolyte layer Preparation Example 1, except that 14.6 parts by weight of 75Li₂S-22P₂₅-3Li₂SO₄ and 14.6 parts by weight of Li₆P₅Cl were used. Here, 75Li₂S-22P₂S₅-3Li₂SO₄:Li₆PS₅Cl has a weight ratio of 50:50.

### Solid Electrolyte Layer Preparation Example 3

A solid electrolyte layer was prepared in the same manner as in solid electrolyte layer Preparation Example 1, except that 7.3 parts by weight of 75Li₂S-22P₂₅-3Li₂SO₄ and 21.9 parts by weight of Li₆PS₅Cl were used. Here, 75Li₂S-22P₂S₅-3Li₂SO₄:Li₆PS₅Cl has a weight ratio of 25:75.

### Solid Electrolyte Layer Comparative Example 1

A solid electrolyte layer was prepared in the same manner as in Solid electrolyte layer Preparation Example 1, except that only 75Li₂S-22P₂S₅-3Li₂SO₄ without Li₆PS₅Cl was used. Here, the solid electrolyte layer contains 100 wt % of 75Li₂S-22P₂S₅-3Li₂SO₄.

### Solid Electrolyte Layer Comparative Example 2

A solid electrolyte layer was prepared in the same manner as in Solid electrolyte layer Preparation Example 1, except that only Li₆P₅Cl without 75Li₂S-22P₂₅-3Li₂SO₄ was used. Here, the solid electrolyte layer contains 100 wt % of Li₆P₅Cl.

Table 1 below shows the weight ratios of 75Li₂S-22P₂₅-3Li₂SO₄:Li₆PS₅Cl according to the above-described All-solid-state battery Examples and Solid electrolyte layer Examples.

TABLE 1

| | the weight ratio of |
|---|---|
| | 75Li₂S—22P₂S₅—3Li₂SO₄:Li₆PS₅Cl |
| Comparative Example 1 | 100:0 |
| Preparation Example 1 | 75:25 |
| Preparation Example 2 | 50:20 |
| Preparation Example 3 | 25:75 |
| Comparative Example 2 | 0:100 |

FIGS. 2A, 2B, 2C, 2D, and 2E are SEM (Scanning Electron Microscope) images showing the microstructures of the composite electrodes in all-solid-state batteries according to All-solid-state battery Comparative Examples 1, 2, and All-solid-state battery Preparation Examples 1 to 3, respectively.

Referring to FIGS. 2A, 2B, 2C, 2D, and 2E, it can be seen that the electrode active material represented by the light-colored mass is in contact with the darker solid electrolyte in each composite electrode. In addition, it can be seen that each composite electrode includes pores (some of the pores marked by red circles) that are seen in the darkest color between the electrode active material and the solid electrolyte. Due to the pores, contact between the electrode active material and the solid electrolyte may be prevented. The composite electrode according to All-solid-state battery Comparative Example 2, which contains only the argyrodite crystalline Li₆P₅Cl powder (100 wt %) as a solid electrolyte, was found to have the largest pore size due to the rigidity of the crystalline solid electrolyte particles. On the other hand, the composite electrodes according to All-solid-state battery Preparation Examples and Comparative Example 1 containing glass ceramic 75Li₂S-22P₂S₅-3Li₂SO₄ as a solid electrolyte seem to have reduced pore size, This is presumed to be because the glass ceramic 75Li₂S-22P₂S₅-3Li₂SO₄ is softer than the crystalline Li₆PS₅Cl, and can deform during pressure molding. However, the composite electrode according to All-solid-state battery Preparation Example 3 including the solid electrolyte containing 25 wt % glass ceramic, 75Li₂S-22P₂S₅-3Li₂SO₄, and 75 wt % crystalline Li₆P₅Cl was found to have almost no pores, indicating that it had the smallest pore size.

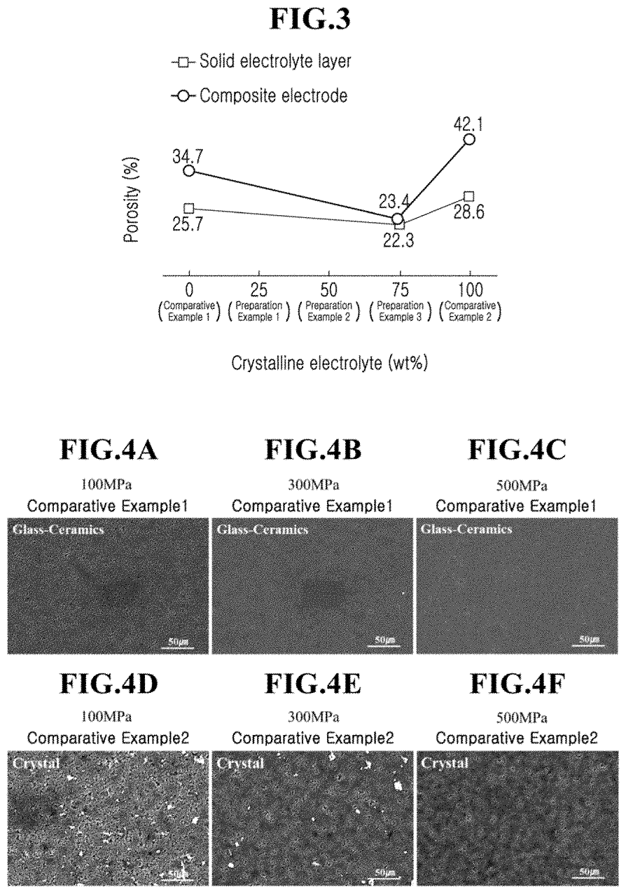

FIG. 3 is a graph showing porosity of solid electrolyte layers according to Solid electrolyte layer Preparation Examples and Solid electrolyte layer Comparative Examples and porosity of composite electrodes of all-solid-state batteries according to All-solid-state battery Preparation Examples and All-solid-state battery Comparative Examples.

Referring to FIG. 3, it can be seen that in Preparation Examples compared to Comparative Examples, porosity has a smaller value. In particular, in Preparation Example 3, it can be seen that the porosity was the smallest. This may mean that the contact area between the electrode active material and the solid electrolyte in the composite electrode according to All-solid-state battery Preparation Example 3 is the largest.

Referring to FIGS. 2A, 2B, 2C, 2D, 2E, and 3, when a solid electrolyte of a composite electrode constituting the all-solid-state battery contains a mixture of a sulfide-based glass ceramic and a sulfide-based crystalline, the contact area between particles in the composite electrode becomes larger. Furthermore, a composite electrode comprising a solid electrolyte in which sulfide-based glass ceramics and sulfide-based crystals are mixed in a specific weight ratio shows a significantly reduced porosity and hardly generates pores, and thus, contact area between the solid electrolyte and the electrode active material in the composite electrode can be greatly improved.

FIGS. 4A, 4B, and 4C are SEM images showing microstructures when molding pressure for the solid electrolyte layer according to Solid electrolyte layer Comparative Example 1 is 100 MPa, 300 MPa, and 500 MPa, respectively, and FIGS. 4D, 4E, and 4F are SEM images showing microstructures when molding pressure for the solid electrolyte layer according to Solid electrolyte layer Comparative Example 2 is 100 MPa, 300 MPa, and 500 MPa, respectively.

FIG. 5 is a graph showing the relative density according to the molding pressure of the solid electrolyte layers according to Solid electrolyte layer Comparative Examples 1 and 2.

Table 2 below summarizes the powder density, hot-pressed density, and apparent density of the solid electrolyte used in Solid electrolyte layer Comparative Examples 1 and 2.

TABLE 2

| | Powder Density | Hot-pressed Density | |
|---|---|---|---|
| | ρ/gcm⁻³ | ρ/gcm⁻³ | Apparent Density |
| | (reference) | (reference) | ρ/gcm⁻³ |
| Comparative | 1.88 | 1.88 | 1.88 |
| Example 1 | | | |
| Comparative | — | — | 2.03 |
| Example 2 | | | |

In Table 2, the powder density refers to true density or particle density, and excludes open pores or closed pores. In addition, the hot-pressed density is a value showing the density of layers (pellets) prepared by hot pressing at a pressure of 3600 MPa at 190° C. Meanwhile, the apparent density is a value that includes the open pores, but the closed pores are excluded.

Referring to FIGS. 4A-4F and 5, and Table 2, since the solid electrolyte according to Comparative Example 1 compared to Comparative Example 2 has a softer property, it can be seen that it has a smaller apparent density value and, as a result, a higher relative density. In particular, as the pressure increased, it can be seen that the difference in relative density between the solid electrolytes according to Comparative Example 1 and Comparative Example 2 appears larger.

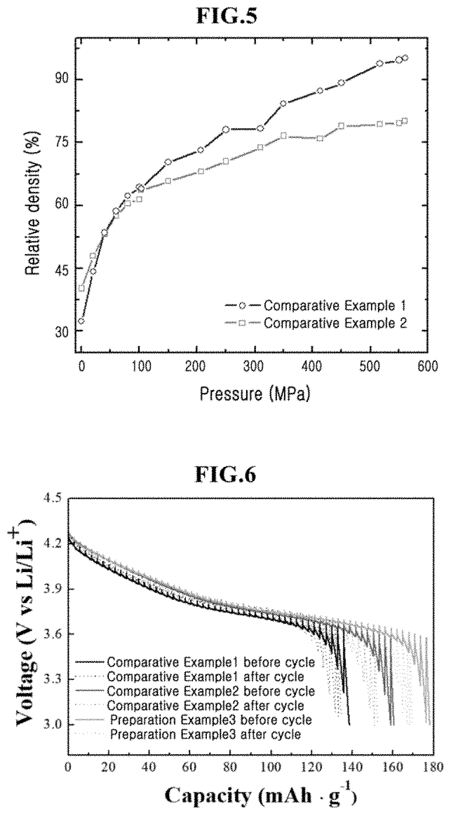

FIG. 6 is a graph showing discharge characteristics of all-solid-state batteries according to All-solid-state battery Examples. Discharge characteristics were measured by charging and discharging once based on the current of 0.1C-rate at a driving voltage of 2.38V to 3.68V.

Referring to FIG. 6, it can be seen that the all-solid-state battery of All-solid-state battery Preparation Example 3 has a larger capacity than all-solid-state batteries of All-solid-state battery Comparative Examples 1 and 2.

Table 3 below shows the contact area between the electrode active material and the solid electrolyte in the composite electrode calculated using the diffusion coefficient of lithium ions using the Galvanostatic Intermittent Titration Technique (GITT) method.

TABLE 3

| | Contact Surface (%) | | |
|---|---|---|---|
| 0.1 C | | State after | |
| Cycle Test | Initial State | Cycle Test | Loss Ratio |
| Comparative | 28.6 | 22.1 | 6.5 |
| Example 1 | | | |
| Preparation | 35.1 | 32.3 | 2.8 |
| Example 3 | | | |
| Comparative | 32.2 | 23.2 | 9.0 |
| Example 2 | | | |

The Initial State represents the ratio of the contact area when charged and discharged once at 0.1C. The State after Cycle Test shows the ratio of the contact area after 5 charge/discharge cycles. The difference in the contact area ratio in these two cases is expressed as the Loss Ratio of the contact area.

It can be seen that the Loss Ratio of the contact area shows the lowest value in the all-solid-state battery according to All-solid-state battery Preparation Example 3, which is a value reduced by more than half compared to the Loss Ratio of the composite electrode shown in the all-solid-state batteries according to All-solid-state battery Comparative Examples 1 and 2.

Accordingly, when the composite electrode includes a solid electrolyte in which a sulfide-based glass ceramic and a sulfide-based crystalline are mixed in a specific weight ratio, it can be seen that the contact area between the electrode active material and the solid electrolyte in the composite electrode in the initial state is not only greatly improved, but also the contact area between the particles in the composite electrode is well maintained and the smooth ion diffusion path between the electrode active materials is maintained even after the volume expansion occurs by charging and discharging of a solid-state battery.

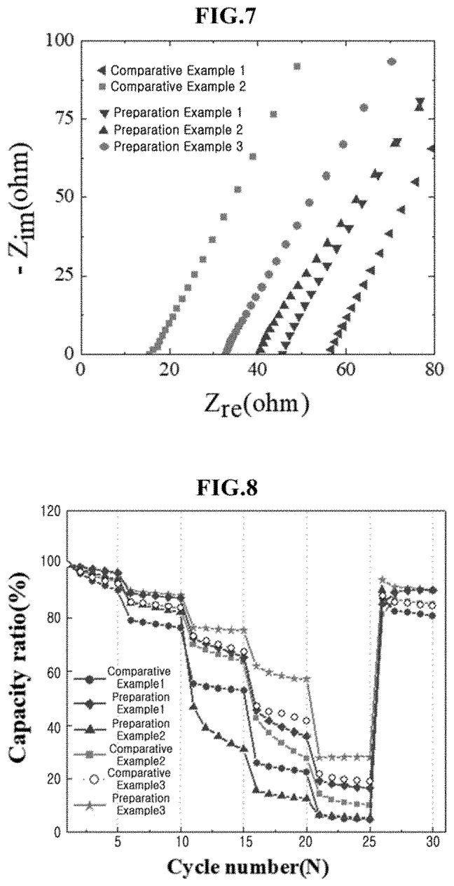

FIG. 7 is a graph showing resistance characteristics of solid electrolyte layers according to Solid electrolyte layer Preparation Examples and Comparative Examples.

Referring to FIG. 7, in the case of the solid electrolyte layers in which a sulfide-based glass ceramic and a sulfide-based crystalline are mixed (Preparation Examples 1 to 3), it can be confirmed that the resistance is increased compared to the solid electrolyte layer of Comparative Example 2 containing only sulfide-based crystalline as a solid electrolyte. However, it can be seen that the resistance is reduced compared to the solid electrolyte layer of Comparative Example 1, which contains only a sulfide-based glass ceramic as a solid electrolyte.

Furthermore, when comparing only the solid electrolyte layers in which a sulfide-based glass ceramic and a sulfide-based crystalline substance are mixed, it can be seen that the solid electrolyte layer of Preparation Example 3 compared to those of Preparation Examples 1 and 2 exhibits the smallest resistance value.

Table 4 below shows the electrical conductivity of the solid electrolyte layer according to Solid electrolyte layer Preparation Examples and Comparative Examples.

TABLE 4

| | electrical conductivity of |
|---|---|
| | solid electrolyte layer |
| Comparative Example 1 | 1.20 × 10⁻³ S/cm |
| Preparation Example 1 | 1.44 × 10⁻³ S/cm |
| Preparation Example 2 | 1.79 × 10⁻³ S/cm |
| Preparation Example 3 | 2.07 × 10⁻³ S/cm |
| Comparative Example 2 | 2.30 × 10⁻³ S/cm |

FIG. 8 is a graph showing rate performance of all-solid-state batteries according to All-solid-state battery Preparation Examples and Comparative Examples. Rate performance was measured by performing charging and discharging five times under each current condition of 0.1C, 0.2C, 0.5C, 1C, 2C, and 0.1C at a driving voltage of 2.38V to 3.68V.

Table 5 below shows the capacity at 0.1C-rate and 0.5C-rate of FIG. 8 and the capacity retention ratio at 0.5C-rate compared to 0.1C-rate.

TABLE 5

| | 0.1 C | 0.5 C | retention ratio |
|---|---|---|---|
| | (mAh/g) | (mAh/g) | (%) |
| Comparative Example 1 | 144.6 | 80.1 | 55.4 |
| Preparation Example 1 | 146.6 | 106.2 | 72.4 |
| Preparation Example 2 | 146.4 | 76.7 | 52.4 |
| Preparation Example 3 | 169.9 | 130 | 76.5 |
| Comparative Example 2 | 158.1 | 110.6 | 30 |
| Comparative Example 3 | 165.4 | 121.2 | 73.2 |

Referring to FIG. 8 and Table 5, it can be seen that the all-solid-state battery according to All-solid-state battery Preparation Example 3 shows the highest capacity value even at a high rate, and the capacity retention ratio is also the best. In addition, it can be seen that the electrochemical properties of the all-solid-state battery according to All-solid-state battery Preparation Example 3 are superior to the chemical properties of the all-solid-state battery according to All-solid-state battery Comparative Example 3 including a mixed solid electrolyte obtained by mixing a solid electrolyte coarse powder and a solid electrolyte fine powder in the composite electrode, which are known to have excellent packing density.

Accordingly, an all-solid-state battery including a composite electrode containing a solid electrolyte in which a sulfide-based glass ceramic and a sulfide-based crystalline are mixed in a specific weight ratio may have excellent rate and life characteristics.

On the other hand, referring to FIG. 7 and Table 4 above, it can be seen that a a solid electrolyte in which a sulfide-based glass ceramic and a sulfide-based crystalline substance are mixed exhibits a smaller ion conductivity compared to a solid electrolyte made of only a sulfide-based crystalline substance (Comparative Example 2).

Although the ionic conductivity is not so excellent, the all-solid-state battery including a composite electrode containing a solid electrolyte in which a sulfide-based glass ceramic and a sulfide-based crystalline are mixed in a specific weight ratio has the best electrochemical properties. These improved electrochemical properties are considered as a result of the improvement in the contact area between the electrode active material and the solid electrolyte in the composite electrode, and the suppression of cracks between particles and the suppression of contact-area loss during charging and discharging.

As described above, the all-solid-state battery according to the embodiment of the present invention has an excellent contact area between particles in the composite electrode included in the all-solid-state battery, so that the electrochemical characteristics of the all-solid-state battery including the same can be improved.

Although described with reference to the above embodiments, those skilled in the art will be able to understand that various modifications and changes can be made to the present invention without departing from the spirit and scope of the present invention as set forth in the claims below.

This work was supported by the Dual Use Technology Program of the Institute of Civil Military Technology Cooperation granted financial resources from the Ministry of Trade, Industry & Energy and Defense Acquisition Program Administration (17-CM-EN-11).

What is claimed is:

1. An all-solid-state battery comprising:
a solid electrolyte layer;
a positive electrode layer disposed on one side of the solid electrolyte layer; and
a negative electrode layer disposed on the other side of the solid electrolyte layer,
wherein at least one of the positive electrode layer and the negative electrode layer is provided with a composite electrode layer comprising an electrode active material and a solid electrolyte,
the solid electrolyte comprises a mixture of a sulfide-based glass ceramic and a sulfide-based crystalline.

2. The all-solid-state battery of claim 1, wherein the sulfide-based glass ceramic has a Young's modulus of 14 to 20 E/GPa, and the sulfide-based crystalline has a Young's modulus of 22 to 30 E/GPa.

3. The all-solid-state battery of claim 1, wherein the solid electrolyte contained in the composite electrode layer includes the sulfide-based crystalline of 10 to 90 weight ratio based on the weight of the mixture of the sulfide-based glass ceramic and the sulfide-based crystalline.

4. The all-solid-state battery of claim 3, wherein the solid electrolyte contained in the composite electrode layer includes the sulfide-based crystalline of 70 to 80 weight ratio.

5. The all-solid-state battery of claim 1, wherein the sulfide-based crystalline has an argyrodite-type crystal structure.

6. The all-solid-state battery of claim 5, wherein the sulfide-based crystalline is Li₆PS₅X, and X is Cl, Br, or I.

7. The all-solid-state battery of claim 1, wherein the sulfide-based glass ceramic includes lithium sulfide and phosphorus sulphide.

8. The all-solid-state battery of claim 7, wherein the sulfide-based glass ceramic further includes a lithium salt.

9. The all-solid-state battery of claim 7, wherein the sulfide-based glass ceramic includes 70 to 80 mol % of the lithium sulfide, 20 to 25 mol % of the phosphorus sulphide, and 0 to 5 mol % of a lithium salt.

10. The all-solid-state battery of claim 9, wherein the lithium salt is lithium sulfate.

11. The all-solid-state battery of claim 1, wherein the positive electrode layer is the composite electrode layer, and the electrode active material contains lithium-transition metal oxide or lithium-transition metal phosphate.

12. The all-solid-state battery of claim 1, wherein the solid electrolyte layer contains a solid electrolyte, and the solid electrolyte contained in the solid electrolyte layer has a different composition from the solid electrolyte contained in the composite electrode layer.

13. The all-solid-state battery of claim 1, wherein the negative electrode layer includes Li, In, Al, Si, Sn, Ti, or any one of these alloys.

14. A composite electrode comprising:
an electrode active material and a solid electrolyte,
wherein the solid electrolyte comprises a mixture of a glass ceramic solid electrode and a crystalline solid electrode.

15. The composite electrode of claim 14, wherein the crystalline solid electrolyte is a sulfide-based crystalline having an argyrodite-type crystal structure.

16. The composite electrode of claim 15, wherein the sulfide-based crystalline is Li₆PS₅X, and X is Cl, Br, or I.

17. The composite electrode of claim 14, wherein the glass ceramic solid electrolyte is a sulfide-based glass ceramic represented by the following Chemical Formula 1 or Chemical Formula 2:
(100-y)(xLi₂S-(1-x)P₂S₅)-y(salt) [Chemical Formula 1]
In the Chemical Formula 1, x is 0.5 to 0.8, and y is 0 to 5.
yLi₂S-(100-y-x)P₂S₅-x(salt) [Chemical Formula 2]
In the Chemical Formula 2, y is 50 to 80, and x is 0 to 5.

18. The composite electrode of claim 17, wherein the salt is lithium salt.

19. The composite electrode of claim 14, wherein the solid electrolyte contains 70 to 80 parts by weight of the crystalline solid electrolyte and 20 to 30 parts by weight of the glass ceramic solid electrolyte.

20. The composite electrode of claim 14, wherein the electrode active material contains lithium-transition metal oxide or lithium-transition metal phosphate.
